(19) United States
(12) Patent Application Publication
(10) Pub. No.: US 2024/0018318 A1
(43) Pub. Date: Jan. 18, 2024

(54) RUSTPROOFING FILM

(71) Applicant: AICELLO CORPORATION, Toyohashi-shi, Aichi (JP)

(72) Inventors: Shiro SAWADA, Toyohashi-shi, Aichi (JP); Tomohiro NIIMI, Toyohashi-shi, Aichi (JP)

(21) Appl. No.: 18/247,225

(22) PCT Filed: Oct. 25, 2021
(86) PCT No.: PCT/JP2021/039206

§ 371 Date: Mar. 29, 2023

(30) Foreign Application Priority Data
Oct. 26, 2020 (JP) 2020-178707

(51) Int. Cl. C08J 5/18; C08L 23/06; C08K 5/098; C08K 3/36; B32B 27/32; B32B 27/08

(52) U.S. Cl. CPC C08J 5/18; C08L 23/06; C08K 5/098; C08K 3/36; B32B 27/32; B32B 27/08; C08K 2201/005; C08K 2201/006; C08L 2207/066; B32B 2307/752; B32B 2250/02; B32B 2250/24; B32B 2323/046

(57) ABSTRACT

An object is to achieve an improved rustproofing effect by allowing an abundance of rustproofing agent to be released efficiently without the resin having to contain a large amount of rustproofing agent. As a solution, a rustproofing film containing (A) to (C) below is provided: (A) a polyolefin-based resin; (B) 0.05 to 1.00% by weight, relative to the rustproofing film, of an alkaline metal salt of carboxylic acid whose average particle size is 100 μm or less and solubility in 50° C. water is 0.1% by weight or more; and (C) 0.05 to 5.00% by weight, relative to the rustproofing film, of particles whose average particle size is 5.0 to 200 μm, aspect ratio is 1.0 to 20.0, and specific surface area is 100 m²/g or less.

### TECHNICAL FIELD

The present invention relates to a rustproofing film.

### BACKGROUND ART

When being used as a material for wrapping a metal product, etc., one method for achieving a long-lasting effect of the rustproofing agent is to have the rustproofing agent dispersed, and thus supported, in a resin. For the resin, in many cases one of nonpolar polyolefin resins is selected, one representative example of which is low-density polyethylene, from the viewpoint of ease of processing; however, the aforementioned resins generally have poor compatibility with rustproofing agents, and therefore controlling the release of rustproofing agents from these resins has been difficult. In addition, allowing more rustproofing agent to be released from these resins has also been difficult.

This means that adding a large amount of rustproofing agent to any such resin in an attempt to release more rustproofing agent can trigger, in a relatively short period of time after the manufacturing of the product, a so-called “bleed-out” or “bloom-out”—phenomenon in which the rustproofing agent deposits on the product's surface—thereby reducing the product's appearance and reducing its value.

Meanwhile, when a metal product is covered with the rustproofing film described in Patent Literature 1, for example, a volatile rustproofing agent released from the rustproofing film is present in a space created between the metal product and the rustproofing film, and therefore rusting of the metal product surface facing this space can be prevented. However, the metal surface in areas where the rustproofing film is adhered to the metal product may not be sufficiently prevented from rusting because these areas do not contact air containing the volatile rustproofing agent. For this reason, sometimes a drying agent is also used or other rustproofing component(s) is added to coexist therewith.

Moreover, the rustproofing agent must be blended into the rustproofing film by a relatively large amount in advance so that the rustproofing effect will not decrease over the period during which the metal product remains wrapped.

### BACKGROUND ART LITERATURE

### Patent Literature

Patent Literature 1: Japanese Patent Laid-open No. 2013-44014

Patent Literature 2: Japanese Patent Laid-open No. 2019-131267

### SUMMARY OF THE INVENTION

### Problems to Be Solved by the Invention

An object of the present invention is to achieve an improved rustproofing effect by allowing an abundance of rustproofing agent to be released efficiently without needing a large amount of rustproofing agent contained in a resin.

### Means for Solving the Problems

As a result of studying in earnest to achieve the aforementioned object, the inventors of the present invention found that the object could be achieved by the following means, and consequently completed the present invention.

1. A rustproofing film containing (A) to (C) below:

(A) a polyolefin-based resin;

(B) 0.05 to 1.00% by weight, relative to the rustproofing film, of an alkaline metal salt of carboxylic acid whose average particle size is 100 μm or less and solubility in 50° C. water is 0.1% by weight or more; and

(C) 0.05 to 5.00% by weight, relative to the rustproofing film, of particles whose average particle size is 5.0 to 200 μm, aspect ratio is 1.0 to 20.0, and specific surface area is 100 m²/g or less.

2. The rustproofing film according to 1, wherein the carboxylic acid in the aforementioned alkaline metal salt of carboxylic acid comprises an aliphatic carboxylic acid and/or aromatic carboxylic acid.

3. The rustproofing film according to 1 or 2, wherein the carboxylic acid in the aforementioned alkaline metal salt of carboxylic acid comprises one or more types selected from C8 to C16 saturated monocarboxylic acids, C8 to C16 saturated dicarboxylic acids, C8 to C22 unsaturated monocarboxylic acids, and C8 to C22 unsaturated dicarboxylic acids.

4. The rustproofing film according to any one of 1 to 3, wherein the aforementioned particles comprise inorganic particles and/or resin particles.

5. A rustproofing film having a rustproofing layer containing (A) to (C) below, as well as a (D) base layer:

(A) a polyolefin-based resin;

(B) 0.05 to 1.00% by weight, relative to the rustproofing layer, of an alkaline metal salt of carboxylic acid whose average particle size is 100 μm or less and solubility in 50° C. water is 0.1% by weight or more; and

(C) 0.05 to 5.00% by weight, relative to the rustproofing layer, of particles whose average particle size is 5.0 to 200 μm, aspect ratio is 1.0 to 20.0, and specific surface area is 100 m²/g or less.

6. The rustproofing film according to 5, wherein the carboxylic acid in the aforementioned alkaline metal salt of carboxylic acid comprises an aliphatic carboxylic acid and/or aromatic carboxylic acid.

7. The rustproofing film according to 5 or 6, wherein the carboxylic acid in the aforementioned alkaline metal salt of carboxylic acid comprises one or more types selected from C8 to C16 saturated monocarboxylic acids, C8 to C16 saturated dicarboxylic acids, C8 to C22 unsaturated monocarboxylic acids, and C8 to C22 unsaturated dicarboxylic acids.

8. The rustproofing film according to any one of 5 to 7, wherein the aforementioned particles comprise inorganic particles and/or resin particles.

### Effects of the Invention

According to the present invention, an improved rustproofing effect can be achieved by allowing more rustproofing agent to be released without the resin having to contain a large amount of rustproofing agent.

### MODE FOR CARRYING OUT THE INVENTION

The present invention is a rustproofing film essentially characterized in that it contains a polyolefin-based resin, a specific rustproofing agent, as well as specific particles.

The rustproofing film proposed by the present invention can be formed to any desired thickness; however, by also using component (C) in the present invention, the film can have a thickness equal or greater than 50 μm which is the thickness of conventional rustproofing films, or it can be made thinner to between 20 and 50 μm. When the film is made thinner, the amount of rustproofing agent used per unit area of the rustproofing film can be reduced.

### (A) Polyolefin-Based Resin

Under the present invention, the polyolefin-based resin being component (A) above is one used for containers, wrapping films, etc.

Specific examples include polyethylene, polypropylene (PP) and other α-olefin homopolymers, ethylene-propylene copolymer, ethylene-butene-1 copolymer, ethylene-4-methyl-1-pentene copolymer, ethylene-hexene copolymer and other copolymers of ethylene with C3 to C8 α-olefins, ethylene-cyclic olefin copolymers in which ethylene is copolymerized with cyclopentadiene, norbornene or other cyclic olefin, ethylene-vinyl acetate (EVA) copolymer, ethylene-acrylic acid copolymer, ethylene-vinyl acetate-methyl methacrylate copolymer and other copolymers of ethylene with a carboxylic acid derivative having ethylenic unsaturated bonds, as well as blends thereof.

Of the aforementioned polyolefin-based resins, selecting polyethylene is appropriate in terms of product cost and simplicity of manufacturing when the intended use is wrapping material, for example, where any of low-density polyethylene (LDPE), linear low-density polyethylene (LLDPE), high-density polyethylene (HDPE), and various other types of polyethylene may be adopted in consideration of their properties.

A preferred density of the polyolefin-based resin is 0.880 to 0.960 g/cm³, where 0.890 g/cm³ or higher is more preferred, and 0.900 g/cm³ or higher is yet more preferred. Meanwhile, 0.950 g/cm³ or lower is more preferred, and 0.930 g/cm³ or lower is yet more preferred.

Also, a preferred MFR of the polyolefin-based resin is 0.1 to 30.0 g/10 min, where 0.5 g/10 min or higher is more preferred, 1.0 g/10 min or higher is yet more preferred, and 1.5 g/10 min or higher is most preferred. Meanwhile, 20.0 g/10 min or lower is more preferred, 10.0 g/10 min or lower is yet more preferred, and 6.0 g/10 min or lower is most preferred.

By using a polyolefin-based resin satisfying the aforementioned ranges, the present invention can be used favorably as a rustproofing film for wrapping various types of metal products having various shapes and weights.

### (B) Alkaline Metal Salt of Carboxylic Acid

The alkaline metal salt of carboxylic acid with a solubility in 50° C. water of 0.1% by weight or more, which is contained in the polyolefin-based resin in (A) above as a rustproofing agent, has an average particle size of 100 μm or less, or preferably 70 μm or less, or more preferably 40 μm or less, or yet more preferably 20 μm or less, or most preferably 15 μm or less. Meanwhile, the average particle size is preferably 0.1 μm or more, or more preferably 0.5 μm or more, or yet more preferably 1.0 μm or more, or most preferably 1.5 μm or more. The greater the average particle size, the greater the possibility that mechanical strength of the film containing the rustproofing agent drops, uneven density occurs, or even the rustproofing action drops, when the density of contained amount remains the same. If the average particle size is under 0.1 μm, on the other hand, the particles of alkaline metal salt of carboxylic acid tend to aggregate, possibly making it difficult to achieve their uniform dispersion in the polyolefin-based resin during the manufacturing of the film.

One or more types of alkaline metal salt of carboxylic acid may be selected and used.

No alkaline metal salt of carboxylic acid, if its solubility in 50° C. water is less than 0.1% by weight, can fully demonstrate rustproofing effect even when it satisfies other requirements under the present invention.

This rustproofing agent is a water-soluble rustproofing agent having a solubility in 50° C. water of 0.1% by weight or more, which means that, when it is to be contained in a nonpolar polyolefin-based resin, it will be dispersed in a particle state in the resin.

Here, the aforementioned average particle size based on long diameter or short diameter is measured using Microtrac's CAMSIZER X2 according to the image analysis method.

It should be noted that, under the present invention, the average particle size of the alkaline metal salt of carboxylic acid represents D50 based on long diameter.

For the aforementioned alkaline metal salt of carboxylic acid, an alkaline metal salt of aliphatic carboxylic acid and/or alkaline metal salt of aromatic carboxylic acid may be used.

The alkaline metal salt of aliphatic carboxylic acid may be either an alkaline metal salt of saturated aliphatic carboxylic acid or alkaline metal salt of unsaturated aliphatic carboxylic acid. Alkaline metal salts of phthalic acid, p-tert-butylbenzoic acid, p-nitrobenzoic acid, benzoic acid, lauric acid, decanoic acid, nonanoic acid, octanoic acid, heptanoic acid, hexanoic acid, caprylic acid, sebacic acid, adipic acid, oleic acid, myristic acid, palmitic acid, succinic acid, citric acid, tartaric acid, etc., may be adopted.

Also, among the alkaline metal salts of saturated monocarboxylic acids and saturated dicarboxylic acids, those of C8 to C16 are preferred, while those of C8 to C14 are more preferred, and those of C8 to C12 are yet more preferred, respectively.

Among the alkaline metal salts of unsaturated monocarboxylic acids and alkaline metal salts of unsaturated dicarboxylic acids, those of C8 to C22 are preferred, while those of C12 to C20 are more preferred, and those of C14 to C18 are yet more preferred.

Among these rustproofing agents, preferably sodium laurate, potassium laurate, sodium caprylate, potassium caprylate, sodium sebacate, potassium sebacate, sodium oleate, potassium oleate, sodium p-tert-butylbenzoate, sodium p-nitrobenzoate, sodium myristate, potassium myristate, sodium palmitate, potassium palmitate, sodium succinate, potassium succinate, sodium citrate, potassium citrate, sodium adipate, potassium adipate, or sodium tartrate is adopted.

Also, as one of these rustproofing agents, sodium benzoate having relatively high volatility may or may not be used.

Besides these alkaline metal salts of carboxylic acids, acids other than carboxylic acids or salts thereof, such as alkaline metal salts and alkaline earth metal salts of benzoic acid, nitrobenzoic acid and other free carboxylic acids as well as nitrous acid, may or may not be contained.

Regarding the blending quantity of the rustproofing agent in (B), an appropriate quantity varies depending on the metal product to be rust-protected and the required rustproofing effect; in general, however, too small a quantity prevents the rustproofing component from dispersing over a wide range and therefore sufficient rustproofing effect cannot be achieved. If the quantity is too large, on the other hand, the physical strength of the rustproofing film may be negatively affected, resulting in a failure to achieve sufficient rustproofing effect.

For these reasons, the rustproofing agent is added in such a way that it accounts for 0.05 to 1.00% by weight relative to the rustproofing film, in order to achieve a stable effect. Furthermore, from the manufacturing viewpoint, it accounts for preferably 0.08% by weight or more, or more preferably 0.10% by weight or more. Meanwhile, it accounts for preferably 0.80% by weight or less, or more preferably 0.60% by weight or less, or yet more preferably 0.50% by weight or less.

The rustproofing agent in (B) under the present invention is not a volatile rustproofing agent, which means that it does not vaporize and thus does not cause any vaporized rustproofing agent to exist in the space wrapped by the rustproofing film. The idea is to wrap the material to be rust-protected with the rustproofing film, lay the rustproofing film underneath the material to be rust-protected or otherwise cause the rustproofing film to contact the material to be rust-protected, so that the rustproofing agent that releases onto the surface of the rustproofing film will make direct contact with the contacting locations of the rust-protected material, thereby preventing rusting of these contacting areas.

Accordingly, sodium benzoate, etc., that also serve as a volatile rustproofing agent, need not be contained.

Also, salts of alkaline metal, alkaline earth metal, etc., of nitrous acid, carbonic acid, phosphoric acid, boric acid, silicic acid, and other inorganic acids having no volatility can be added, as necessary, to further improve the rustproofing effect.

Meanwhile, organic acid amides and other volatile rustproofing agents, as well as ammonium nitrate, ammonium borate, inorganic amine salt, amine salt of carboxylic acid, triazole-based, and other rustproofing agents need not be blended in.

These rustproofing agents exhibit rustproofing property when blended in by the necessary quantity, regardless of the presence of the particles (C).

### (C) Particles

With respect to the particles that are blended in under the present invention, it is necessary that they maintain their shape as a particle in the olefin-based resin and also during the processing thereof under heating and melting conditions, etc. The particle surface may be either hydrophilic or hydrophobic, but the rustproofing agent can be released more swiftly when it is hydrophilic. In the rustproofing film proposed by the present invention, the rustproofing agent can move along this particle surface, and consequently more rustproofing agent can be moved to the surface of the rustproofing film more quickly. It should be noted that cellulose fiber or other fibrous substance may or may not be contained.

It should also be noted that, as a means for hydrophobizing the particle surface, a means to treat the silanol groups, etc., of silica, etc., at the surface with polydimethyl siloxane, methyl chlorosilane, hexamethyl disilazane, or other surface treatment agent may be adopted.

These particles may be either water-insoluble inorganic particles or resin particles that are not a rustproofing agent. Glass beads, silica, alumina, calcium carbonate, polymethyl methacrylate (PMMA) particles, or particles constituted by (meth)acrylic resin, polyester resin, polyamide resin, polyurethane resin, silicone resin, or other known resin may be adopted. Of these, silica and calcium carbonate are preferred. Also, the particle surface may be porous, or it may not be porous. It should be noted that particles that themselves have free acid radicals or possess reactivity to or solubility in water, such as particles of hydroxides of alkaline metals and alkaline earth metals, oxidizable metal powders, silicate, and nitrobenzoic acid, for example, need not be adopted.

Even when the particles are porous, their specific surface area is limited at the upper end to 100 m²/g. The specific surface area of the particles is preferably 80 m²/g or less, or more preferably 50 m²/g or less, or yet more preferably 30 m²/g or less, or most preferably 20 m²/g or less. The greater the specific surface area of the particles, the more the fine pores exist at their surface, which facilitates entry, adsorption, or retention of the rustproofing agent in these pores. As a result, the amount of rustproofing agent that moves toward the surface of the rustproofing film decreases or the movement is delayed, thereby lowering or delaying the rustproofing effect.

Furthermore, the particles must have an average particle size of 5.0 to 200 μm,

and if this average particle size is smaller than 5.0 μm, moving the rustproofing agent to the surface of the rustproofing film along the particle surface becomes difficult. On the other hand, an average particle size greater than 200 μm leads to a drop in mechanical strength of the rustproofing film. Among such particles with an average particle size of 5.0 to 200 μm, those with an average particle size of 100 μm or less are preferred, those with an average particle size of 60 μm or less are more preferred, those with an average particle size of 30 μm or less are yet more preferred, and those with an average particle size of 20 μm or less are most preferred.

Meanwhile, those with an average particle size of 6.0 μm or more are preferred, and those with an average particle size of 7.0 μm or more are more preferred.

It should be noted that this average particle size represents the value of the short diameter of the particle, while the average particle size based on long diameter or short diameter is expressed as D50, measured using Microtrac's CAMSIZER X2 according to the image analysis method.

Ideally the resin particles and inorganic particles are spherical in shape. If they are in bar form or flake form, sufficient effect may not be demonstrated, and therefore ideally their aspect ratio is 1.0 to 20.0.

If the aspect ratio exceeds 20.0, the particles tend to inhibit the movement of the alkaline metal salt of carboxylic acid in the rustproofing film toward the surface of the rustproofing film, thereby preventing swift release of the rustproofing agent and making it difficult to sufficiently demonstrate the rustproofing effect.

Furthermore, among the particles with an aspect ratio of 1.0 to 20.0, those with an aspect ratio of 18.0 or less are preferred, those with an aspect ratio of 10.0 or less are more preferred, those with an aspect ratio of 5.0 or less are yet more preferred, and those with an aspect ratio of 2.0 or less are most preferred.

Also, while these particles are blended in so that they account for 0.05 to 5.00% by weight in the rustproofing film, this percentage is preferably 0.20% by weight or more, or more preferably 0.50% by weight or more, or yet more preferably 0.70% by weight or more. Meanwhile, it is preferably 4.00% by weight or less, or more preferably 3.00% by weight or less, or yet mor preferably 2.00% by weight or less, or most preferably 1.50% by weight or less.

If the content of these particles is lower than 0.05% by weight, the effect of blending in the particles cannot be sufficiently achieved and the movement of the rustproofing agent toward the surface of the rustproofing film is impeded. If the content of the particles exceeds 5.00% by weight, on the other hand, the particles in the rustproofing film may affect the mechanical strength of the rustproofing film.

It should be noted that, while other particles may be contained in addition to the particles in (C) under the present invention, in this case it is necessary that such other particles are contained to the extent that the effects of the present invention are not impaired. And, an effect of the present invention is a corrosion area ratio of preferably 0.10% or less, or more preferably 0.08% or less, after 7 days under the conditions of experiments in the examples below.

In the rustproofing film and rustproofing layer proposed by the present invention, preferably the content of the particles (C) relative to the content of the alkaline metal salt of carboxylic acid (B) is 0.05 to 100 times. When the content ratio is within this range, the presence of the particles (C) facilitates the release of the alkaline metal salt of carboxylic acid (B) from the rustproofing film and rustproofing layer, and the rustproofing effect tends to improve.

Also, preferably the content of the alkaline metal salt of carboxylic acid (B) relative to the content of the particles (C) is 0.01 to 20 times. When the content ratio is within this range, the presence of the particles (C) facilitates the release of the alkaline metal salt of carboxylic acid (B) from the rustproofing film, and the rustproofing effect tends to improve.

Rustproofing film comprising the rustproofing layer containing (A) to (C) above, and the base layer (D), are stacked on top of each other.

The base layer in (D) is a layer stacked on one side of the rustproofing layer containing (A) to (C) above. The rustproofing layer may be provided over the entire surface, or on parts thereof, of the base layer, or conversely the base layer may be provided on parts of the surface of the rustproofing layer.

If the base layer in (D) is provided, the material to be rust-protected is placed and/or wrapped in a manner contacting the rustproofing layer side, not the base layer side, of the film.

The rustproofing film having the base layer can be formed by any general method employed for laminates having multiple resin layers, such as forming the base layer on one side of the rustproofing layer by means of lamination, coextrusion, etc., or applying a solution or molten matter containing the material with which to constitute one of the rustproofing layer and base layer, on one side of the other.

The base layer is constituted by a material that can be stacked with the rustproofing layer, and does not inhibit, in terms of material or structure, the intended use of the rustproofing film such as wrapping.

For example, polyolefin-based resin, polyamide-based resin, vinyl chloride-based resin, polyester-based resin, acrylic-based resin, or other known resin may be adopted for the base layer. Also, regarding the shape of the base layer, a layer in film/sheet form may be adopted, and a cloth/woven fabric, nonwoven fabric, etc., may be adopted.

The base layer may be provided simply as a support layer not containing any rustproofing agent, while any of other known rustproofing agents including the aforementioned alkaline metal salts of carboxylic acids and/or volatile rustproofing agents may also be blended in the base layer.

It should be noted that, when covering the metal product to be rust-protected with the rustproofing film proposed by the present invention, the film may be placed so that its base layer side faces the metal product to be rust-protected, or conversely so that its rustproofing layer side faces the metal product to be rust-protected.

### Other Components

Other components that can be blended in the rustproofing film containing (A) to (C) as proposed by the present invention, or in each layer of the rustproofing film having the rustproofing layer containing (A) to (C) and the base layer (D) also as proposed by the present invention, include colorant, plasticizer, photostabilizer, slip agent, anti-static agent, and other known additives that can be blended in resins, to the extent that they do not impair the effects of the present invention.

Also, regarding the method for manufacturing the rustproofing film proposed by the present invention, any known means for manufacturing a single-layer or multi-layer film may be adopted.

The present invention is explained more specifically below by citing examples; however, the present invention is not limited by the following examples in the first place, and it is certainly possible to implement the present invention by adding modifications thereto, to the extent that the purposes mentioned above and below can still be complied with, and each such implementation is also included in the technical scope of the present invention.

Test of Contact Rustproofing Action (This Was Evaluated by Obtaining the Corrosion Area Ratio)

Test piece: Cast iron (Fc250, shaped as a ϕ30×9 mm thick disk)

Test piece wrapping mode: The test piece was inserted in a bag created by heat-sealing two rustproofing films of 60 mm long×90 mm wide along the edges, and the bag was hung in a space conforming to the test environment.

Test environment: Temperature 50° C., humidity 95%

Test periods: 1 day, 7 days, 30 days

Evaluation criteria: Corrosion area ratio

The test piece completing the test was photographed with Hirox's digital microscope KH-1300 (6× magnification) and the image data was binarized using the image processing software ImageJ to obtain the corrosion area ratio.

Contact rustproofing action→Excellent: Corrosion area ratio after 1, 7, or 30 days is 0.10% or lower.

Contact rustproofing action→Poor: Corrosion area ratio after 1, 7, or 30 days is 0.11% or higher.

### EXAMPLES

Specific Examples and Comparative Examples of the present invention are explained below.

Tables 1 to 3 list the respective components used in the Examples or Comparative Examples, while the numerical values in Tables 4 onward indicate the contents (% by weight) and results. Also, the results in Tables 7 onward represent the resulting corrosion area ratios when A-1 was used as ingredient A. Tables 5 to 10 show the results when 80-μm thick films were used.

TABLE 1
Ingredient A (Polyolefin-based resin)

| | A-1 | A-2 | A-3 | A-4 | A-5 |
|---|---|---|---|---|---|
| Ingredient A | LDPE | LLDPE | HDPE | Random PP | EVA |
| Density | 0.928 | 0.912 | 0.954 | 0.89 | 0.926 |
| (g/cm³) | | | | | |
| MFR | 2.0 | 2.0 | 1.1 | 1.5 | 2.0 |
| (g/10 min) | | | | | |

TABLE 2
Ingredient B (Alkaline metal salt of carboxylic acid)

| | B-1 | B-2 | B-3 | B-4 | B-5 | B-6 |
|---|---|---|---|---|---|---|
| | Sodium | Sodium | Sodium | Sodium | Sodium | Sodium |
| Ingredient B | laurate | sebacate | benzoate | caprylate | oleate | stearate |
| Solubility | 0.1% or more | | | | | Under |
| | | | | | | 0.1% |
| Average | 2.7 | 2.8 | 86 | 3.6 | 10 | 5.1 |
| particle | | | | | | |
| size (μm) | | | | | | |

TABLE 3
Ingredient C (Particles)

| | | | C-3 | | C-5 | | C-7 | |
|---|---|---|---|---|---|---|---|---|
| | C-1 | C-2 | Porous | C-4 | Calcium | C-6 | Calcium | C-8 |
| Ingredient C | Colloidal silica | | silica | PMMA | carbonate | Mica | carbonate | PMMA |
| Shape | Spherical | | | | Block | Sheet | Needle | Spherical |
| Particle | 14 | 18 | 10 | 10 | 10 | 24 | 20 | 100 |
| size (long | | | | | | | | |
| diameter) | | | | | | | | |
| (μm) | | | | | | | | |
| Particle | 14 | 18 | 10 | 10 | 10 | 0.3 | 1 | 100 |
| size | | | | | | | | |
| (short | | | | | | | | |
| diameter) | | | | | | | | |
| (μm) | | | | | | | | |
| Aspect | 1 | 1 | 1 | 1 | 1 | 80 | 20 | 1 |
| ratio | | | | | | | | |
| Specific | 30 | 30 | 50 | 1 | 1 | 10 | 15 | 1 |
| surface | | | | | | | | |
| area | | | | | | | | |
| (m²/g) | | | | | | | | |
| Surface | Untreated | Hydrophobized | Untreated | Untreated | Untreated | Untreated | Untreated | Untreated |
| treatment | | | | | | | | |

| | C-9 | C-10 | C-11 | C-12 | C-13 | C-14 | C-15 | C-16 |
|---|---|---|---|---|---|---|---|---|
| Ingredient C | PMMA | | Colloidal silica | | | | PMMA | |
| Shape | Spherical | | | | | | | |
| Particle | 30 | 10 | 18 | 8 | 6.2 | 3.9 | 3 | 0.8 |
| size (long | | | | | | | | |
| diameter) | | | | | | | | |
| (μm) | | | | | | | | |
| Particle | 30 | 10 | 18 | 8 | 6.2 | 3.9 | 3 | 0.8 |
| size (short | | | | | | | | |
| diameter) | | | | | | | | |
| (μm) | | | | | | | | |
| Aspect | 1 | 1 | 1 | 1 | 1 | 1 | 1 | 1 |
| ratio | | | | | | | | |
| Specific | 1 | 1 | 30 | 30 | 30 | 30 | 1 | 1 |
| surface | | | | | | | | |
| area | | | | | | | | |
| (m²/g) | | | | | | | | |
| Surface | Untreated | Untreated | Untreated | Untreated | Untreated | Untreated | Untreated | Untreated |
| treatment | | | | | | | | |

TABLE 4

| | Film | | | | | | Ingredient | Ingredient | Corrosion | |
|---|---|---|---|---|---|---|---|---|---|---|
| | thickness | Ingredient A | | | | | B | C | area ratio | |
| | (μm) | A-1 | A-2 | A-3 | A-4 | A-5 | B-1 | C-1 | 1 day | 7 days |
| Example 1 | 50 | 98.5 | | | | | 0.5 | 1 | 0% | 0.04% |
| Example 2 | 80 | 98.5 | | | | | 0.5 | 1 | 0% | 0% |
| Example 3 | 100 | 98.5 | | | | | 0.5 | 1 | 0% | 0% |
| Example 4 | 200 | 98.5 | | | | | 0.5 | 1 | 0% | 0% |
| Example 5 | 80 | | 98.5 | | | | 0.5 | 1 | 0% | 0% |
| Example 6 | 80 | | | 98.5 | | | 0.5 | 1 | 0% | 0% |
| Example 7 | 80 | | | | 98.5 | | 0.5 | 1 | 0% | 0% |
| Example 8 | 80 | | | | | 98.5 | 0.5 | 1 | 0% | 0% |

TABLE 5

| | Ingredient | | | | | | | Ingredient | Corrosion | |
|---|---|---|---|---|---|---|---|---|---|---|
| | A | Ingredient B | | | | | | C | area ratio | |
| | A-1 | B-1 | B-2 | B-3 | B-4 | B-5 | B-6 | C-1 | 1 day | 7 days |
| Example 9 | 98.5 | 0.5 | | | | | | 1 | 0% | 0% |
| Example 10 | 98.5 | | 0.5 | | | | | 1 | 0% | 0% |
| Example 11 | 98.5 | | | 0.5 | | | | 1 | 0% | 0% |
| Example 12 | 98.5 | | | | 0.5 | | | 1 | 0% | 0% |
| Example 13 | 98.5 | | | | | 0.5 | | 1 | 0% | 0% |
| Example 14 | 98.5 | | | 0.25 | 0.25 | | | 1 | 0% | 0% |
| Example 15 | 98.5 | 0.25 | 0.25 | | | | | 1 | 0% | 0% |
| Comparative | 98.5 | | | | | | 0.5 | 1 | 0.15% | 0.43% |
| Example 1 | | | | | | | | | | |
| Comparative | 99.5 | 0.5 | | | | | | 0 | 0.06% | 0.19% |
| Example 2 | | | | | | | | | | |

TABLE 6

| | Ingredient | Ingredient | | | | | | | | | Corrosion | |
|---|---|---|---|---|---|---|---|---|---|---|---|---|
| | A | B | Ingredient C | | | | | | | | area ratio | |
| | A-1 | B-1 | C-1 | C-2 | C-3 | C-4 | C-5 | C-6 | C-7 | C-8 | 1 day | 7 days |
| Example 16 | 98.5 | 0.5 | 1 | | | | | | | | 0% | 0% |
| Example 17 | 98.5 | 0.5 | | 1 | | | | | | | 0% | 0% |
| Example 18 | 98.5 | 0.5 | | | 1 | | | | | | 0% | 0% |
| Example 19 | 98.5 | 0.5 | | | | 1 | | | | | 0% | 0% |
| Example 20 | 98.5 | 0.5 | | | | | 1 | | | | 0% | 0% |
| Example 21 | 98.5 | 0.5 | | | 0.5 | | 0.5 | | | | 0% | 0% |
| Example 22 | 98.5 | 0.5 | | | | | | | | 1 | 0% | 0% |
| Comparative | 98.5 | 0.5 | | | | | | 1 | | | 0.04% | 0.13% |
| Example 3 | | | | | | | | | | | | |
| Comparative | 98.5 | 0.5 | | | | | | | 1 | | 0.06% | 0.17% |
| Example 4 | | | | | | | | | | | | |

| | | | |
|---|---|---|---|
| Ingredient | Ingredient | | Corrosion |
| A | B | Ingredient C | area ratio |

| | A-1 | B-1 | C-9 | C-10 | C-11 | C-12 | C-13 | C-14 | C-15 | C-16 | 1 day | 7 days |
|---|---|---|---|---|---|---|---|---|---|---|---|---|
| Example 23 | 98.5 | 0.5 | 1 | | | | | | | | 0% | 0% |
| Example 24 | 98.5 | 0.5 | | 1 | | | | | | | 0% | 0% |
| Example 25 | 98.5 | 0.5 | | | 1 | | | | | | 0% | 0% |
| Example 26 | 98.5 | 0.5 | | | | 1 | | | | | 0% | 0% |
| Example 27 | 98.5 | 0.5 | | | | | 1 | | | | 0% | 0.04% |
| Example 28 | 98.5 | 0.5 | | | | | 0.5 | 0.5 | | | 0% | 0.06% |
| Comparative | 98.5 | 0.5 | | | | | | 1 | | | 0.06% | 0.17% |
| Example 5 | | | | | | | | | | | | |
| Comparative | 98.5 | 0.5 | | | | | | | 1 | | 0.06% | 0.17% |
| Example 6 | | | | | | | | | | | | |
| Comparative | 98.5 | 0.5 | | | | | | | | 1 | 0.07% | 0.18% |
| Example 7 | | | | | | | | | | | | |

TABLE 7

| 1 day after | | C-11 (% by weight) | | | | | | |
|---|---|---|---|---|---|---|---|---|
| start of test | | 0 | 0.05 | 0.1 | 0.25 | 0.5 | 1 | 5 |
| B-1 | 0 | 0.86% | | | | | 0.79% | |
| (% by | 0.05 | 0.17% | 0.06% | | | | 0% | |
| weight) | 0.1 | 0.13% | | 0.04% | | | 0% | |
| | 0.25 | 0.08% | | | 0% | | | |
| | 0.5 | 0.06% | | | | 0% | 0% | |
| | 1 | 0.06% | 0% | 0% | 0% | 0% | 0% | 0% |

TABLE 8

| 7 days after | | C-11 (% by weight) | | | | | | |
|---|---|---|---|---|---|---|---|---|
| start of test | | 0 | 0.05 | 0.1 | 0.25 | 0.5 | 1 | 5 |
| B-1 | 0 | 2.70% | | | | | 2.60% | |
| (% by | 0.05 | 0.30% | 0.08% | | | | 0.06% | |
| weight) | 0.1 | 0.26% | | 0.08% | | | 0.06% | |
| | 0.25 | 0.19% | | | 0.06% | | | |
| | 0.5 | 0.19% | | | | 0.05% | 0% | |
| | 1 | 0.17% | 0.06% | 0.06% | 0.04% | 0.04% | 0% | 0% |

TABLE 9

| 30 days after | | C-11 (% by weight) | | | | | | |
|---|---|---|---|---|---|---|---|---|
| start of test | | 0 | 0.05 | 0.1 | 0.25 | 0.5 | 1 | 5 |
| B-1 | 0 | 5.70% | | | | | 5.60% | |
| (% by | 0.05 | 0.49% | 0.10% | | | | 0.08% | |
| weight) | 0.1 | 0.41% | | 0.09% | | | 0.06% | |
| | 0.25 | 0.35% | | | 0.06% | | | |
| | 0.5 | 0.29% | | | | 0.05% | 0% | |
| | 1 | 0.25% | 0.08% | 0.08% | 0.04% | 0.04% | 0% | 0% |

TABLE 10

| | | | | | Corrosion area ratio | |
|---|---|---|---|---|---|---|
| | A-1 | B-1 | C-11 | C-2 | 1 day | 7 days |
| Example 29 | 98 | 0.1 | 1 | | 0% | 0.06% |
| Example 30 | 98 | 0.1 | | 1 | 0.02% | 0.07% |
| Comparative | 98 | 0.1 | | | 0.13% | 0.26% |
| Example 8 | | | | | | |

In Table 4, Examples 1 to 8 where the polyolefin-based resin is one of A-1 to A-5, demonstrated high contact rustproofing action due to the combination of B-1 and C-1.

In Table 5, Examples 9 to 15 using one of B-1 to B-5 with a solubility in 50° C. water of 0.1% or more as a rustproofing agent, resulted in a corrosion area ratio of 0%. On the other hand, Comparative Example 1 using B-6 with this solubility under 0.1% failed to achieve excellent rustproofing action as the corrosion area ratio registered 0.15% after 1 day and 0.43% after 7 days.

Comparative Example 2 represents an example free of ingredient C, where the corrosion area ratio was 0.06% after 1 day and 0.19% after 7 days.

In Table 6, Examples 16 to 27 represent examples of using C-1 to C-5 and C-8 to C-13 as the ingredient C particles whose average particle size (short diameter) is 5.0 to 200 μm, aspect ratio is 1.0 to 20.0, and specific surface area is 100 m²/g or less, where the corrosion area ratio after 1 day was 0%. On the other hand, Comparative Examples 3 to 7, representing examples of using C-6, C-7, and C-14 to C-16 whose average particle size (short diameter) is under 5.0 μm, resulted in a drop in contact rustproofing action. Example 28, containing 0.05% by weight or more of particles with an average particle size of 5.0 μm or more, such as C-13, produced a corrosion area ratio of 0% after 1 day, even though particles with an average particle size under 5.0 inn, such as C-14, were also contained. The corrosion area ratio after 7 days was 0.06%, indicating sufficient contact rustproofing action.

In Table 7, adding B-1 by 1.0% by weight to the rustproofing film with a C-11 content therein of 0% by weight, resulted in a corrosion area ratio of 0.06%. On the other hand, the film with its B-1 content adjusted to one-twentieth, or 0.05% by weight, achieved the same corrosion area ratio of 0.06% because it contained 0.05% by weight of C-11 that is not a rustproofing agent. Furthermore, the film containing 1% by weight of C-11 demonstrated an excellent effect manifesting in a corrosion area ratio of 0%, simply because 0.05% by weight of B-1 was blended in.

Similarly, in Table 8, adding B-1 by 1% by weight to the rustproofing film with a C-11 content therein of 0% by weight, resulted in a corrosion area ratio of 0.17%. On the other hand, the film with its B-1 content adjusted to one-twentieth, or 0.05% by weight, achieved further improvement in contact rustproofing action as demonstrated by a corrosion area ratio of 0.08%, because it contained 0.05% by weight of C-11 that is not a rustproofing agent. Furthermore, the film containing 1% by weight of C-11 demonstrated an excellent effect manifesting in a corrosion area ratio of 0.06%, simply because 0.05% by weight of B-1 was blended in.

In Table 9, adding B-1 by 1% by weight to the rustproofing film with a C-11 content therein of 0% by weight, resulted in a corrosion area ratio of 0.25%. On the other hand, the film with its B-1 content adjusted to one-twentieth, or 0.05% by weight, achieved further improvement in contact rustproofing action and the corrosion area ratio was 0.10%, because it contained 0.05% by weight of C-11 that is not a rustproofing agent. Furthermore, the film containing 1% by weight of C-11 demonstrated an excellent effect manifesting in a corrosion area ratio of 0.08%, simply because 0.05% by weight of B-1 was blended in.

According to these results, the content of rustproofing agent necessary for preventing rust can be reduced substantially when particles are contained that are not a rustproofing agent and have a specific average particle size, aspect ratio, and specific surface area.

Also, as shown in Table 10, adopting C-11 being a colloidal silica with untreated surface in Example 29 led to a corrosion area ratio of 0% after 1 day and 0.06% after 7 days. In Example 30, this ratio was 0.02% and 0.07% after 1 day and 7 days, respectively, when C-2 being a colloidal silica with hydrophobized surface was adopted. As shown in Comparative Example 8, however, the ratio was 0.13% and 0.26% after 1 day and 7 days, respectively, when no colloidal silica was contained.

According to these results, the colloidal silica with untreated surface produced slightly better contact rustproofing action compared to the treated colloidal silica.

1. A rustproofing film containing (A) to (C) below:
(A) a polyolefin-based resin;
(B) 0.05 to 1.00% by weight, relative to the rustproofing film, of an alkaline metal salt of carboxylic acid whose average particle size is 100 μm or less and solubility in 50° C. water is 0.1% by weight or more; and
(C) 0.05 to 5.00% by weight, relative to the rustproofing film, of particles whose average particle size is 5.0 to 200 μm, aspect ratio is 1.0 to 20.0, and specific surface area is 100 m²/g or less.

2. The rustproofing film according to claim 1, wherein the carboxylic acid in the alkaline metal salt of carboxylic acid comprises an aliphatic carboxylic acid and/or aromatic carboxylic acid.

3. The rustproofing film according to claim 1, wherein the carboxylic acid in the alkaline metal salt of carboxylic acid comprises one or more types selected from C8 to C16 saturated monocarboxylic acids, C8 to C16 saturated dicarboxylic acids, C8 to C22 unsaturated monocarboxylic acids, and C8 to C22 unsaturated dicarboxylic acids.

4. The rustproofing film according to claim 1, wherein the particles comprise inorganic particles and/or resin particles.

5. A rustproofing film having a rustproofing layer containing (A) to (C) below, as well as a (D) base layer:
(A) a polyolefin-based resin;
(B) 0.05 to 1.00% by weight, relative to the rustproofing layer, of an alkaline metal salt of carboxylic acid whose average particle size is 100 μm or less and solubility in 50° C. water is 0.1% by weight or more; and
(C) 0.05 to 5.00% by weight, relative to the rustproofing layer, of particles whose average particle size is 5.0 to 200 μm, aspect ratio is 1.0 to 20.0, and specific surface area is 100 m²/g or less.

6. The rustproofing film according to claim 5, wherein the carboxylic acid in the alkaline metal salt of carboxylic acid comprises an aliphatic carboxylic acid and/or aromatic carboxylic acid.

7. The rustproofing film according to claim 5, wherein the carboxylic acid in the alkaline metal salt of carboxylic acid comprises one or more types selected from C8 to C16 saturated monocarboxylic acids, C8 to C16 saturated dicarboxylic acids, C8 to C22 unsaturated monocarboxylic acids, and C8 to C22 unsaturated dicarboxylic acids.

8. The rustproofing film according to claim 5, wherein the particles comprise inorganic particles and/or resin particles.

9. The rustproofing film according to claim 2, wherein the carboxylic acid in the alkaline metal salt of carboxylic acid comprises one or more types selected from C8 to C16 saturated monocarboxylic acids, C8 to C16 saturated dicarboxylic acids, C8 to C22 unsaturated monocarboxylic acids, and C8 to C22 unsaturated dicarboxylic acids.

10. The rustproofing film according to claim 2, wherein the particles comprise inorganic particles and/or resin particles.

11. The rustproofing film according to claim 3, wherein the particles comprise inorganic particles and/or resin particles.

12. The rustproofing film according to claim 6, wherein the carboxylic acid in the alkaline metal salt of carboxylic acid comprises one or more types selected from C8 to C16 saturated monocarboxylic acids, C8 to C16 saturated dicarboxylic acids, C8 to C22 unsaturated monocarboxylic acids, and C8 to C22 unsaturated dicarboxylic acids.

13. The rustproofing film according to claim 6, wherein the particles comprise inorganic particles and/or resin particles.

14. The rustproofing film according to claim 7, wherein the particles comprise inorganic particles and/or resin particles.

15. The rustproofing film according to claim 9, wherein the particles comprise inorganic particles and/or resin particles.

16. The rustproofing film according to claim 12, wherein the particles comprise inorganic particles and/or resin particles.
